(19) United States
(12) Patent Application Publication
(10) Pub. No.: US 2017/0083000 A1
(43) Pub. Date: Mar. 23, 2017

(54) Petri Net-based Scheduling of Time Constrained Single-arm Cluster Tools with Wafer Revisiting

(71) Applicant: Macau University of Science and Technology, Macau (MO)

(72) Inventors: Naiqi Wu, Macau (MO); Zicheng Liu, Macau (MO)

(21) Appl. No.: 14/918,570

(22) Filed: Oct. 21, 2015

Related U.S. Application Data
(60) Provisional application No. 62/221,028, filed on Sep. 20, 2015.

(51) Int. Cl. G05B 19/402; B25J 9/00; B25J 9/16; B25J 11/00

(52) U.S. Cl. CPC G05B 19/402; B25J 11/0095; B25J 9/0087; B25J 9/1682; G05B 2219/40238; Y10S 901/02; Y10S 901/41

(57) ABSTRACT

It is very difficult to schedule a single-arm cluster tool with wafer revisiting such that wafer residency time constraints are satisfied. The present invention conducts a study on this challenging problem for a single-arm cluster tool with atomic layer deposition (ALD) process. With a so called p-backward strategy being applied, a Petri net model is developed to describe the dynamic behavior of the system. Based on the model, existence of a feasible schedule is analyzed, schedulability conditions are derived, and scheduling algorithms are presented if there is a schedule. A schedule is obtained by simply setting the robot waiting time if schedulable and it is very computationally efficient. The obtained schedule is shown to be optimal. Illustrative examples are given to demonstrate the proposed approach.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims the benefit of U.S. Provisional Patent Application No. 62/221,028, filed on Sep. 20, 2015, which is incorporated by reference herein in its entirety.

### FIELD OF THE INVENTION

The present invention relates to a method for scheduling time constrained single-arm cluster tools with wafer revisiting.

### BACKGROUND

The following references are cited in the specification. Disclosures of these references are incorporated herein by reference in their entirety.

### LIST OF REFERENCES

W. K. V. Chan, J. G. Yi, and S. Ding, “Optimal Scheduling of Multicluster Tools With Constant Robot Moving Times, Part I: Two-Cluster Analysis,” IEEE Transactions on Automation Science and Engineering, vol. 8, no. 1, pp. 5-16, January 2011.
S. Ding, J. G. Yi, and M. T. Zhang, “Multicluster tools scheduling: an integrated event graph and network model approach,” IEEE Transactions on Semiconductor Manufacturing, vol. 19, no. 3, pp. 339-351, August 2006.
C. Jung and T.-E. Lee, “An Efficient Mixed Integer Programming Model Based on Timed Petri Nets for Diverse Complex Cluster Tool Scheduling Problems,” IEEE Transactions on Semiconductor Manufacturing, vol. 25, no. 2, pp. 186-199, May 2012.
D.-K. Kim, Y.-J. Jung, C. Jung, and T.-E. Lee, “Cyclic scheduling of cluster tools with nonidentical chamber access times between parallel chambers,” IEEE Transactions on Semiconductor Manufacturing, vol. 25, no. 3, pp. 420-431, August 2012.
J.-H. Kim, T.-E. Lee, H.-Y. Lee, and D.-B. Park, “Scheduling analysis of time-constrained dual-armed cluster tools,” IEEE Transactions on Semiconductor Manufacturing, vol. 16, no. 3, pp. 521-534, August 2003.
H.-J. Kim, J.-H. Lee, and T.-E. Lee, “Noncyclic scheduling of cluster tools with a branch and bound algorithm,” IEEE Transactions on Automation Science and Engineering, vol. 12, no. 2, pp. 690-700, 2015.
H.-J. Kim, J.-H. Lee, C. Jung, and T.-E. Lee, “Scheduling cluster tools with ready time constraints for consecutive small lots,” IEEE Transactions on Automation Science and Engineering, vol. 10, no. 1, pp. 145-159, January 2013.
H.-Y. Lee and T.-E. Lee, “Scheduling single-armed cluster tools with reentrant wafer flows,” IEEE Transactions on Semiconductor Manufacturing, vol. 19, no. 2, pp. 226-240, May 2006.
T.-E. Lee, H.-Y. Lee, and Y.-H. Shin, “Workload balancing and scheduling of a single-armed cluster tool,” in Proc. of the 5th APIEMS Conf., pp. 1-15, Gold Coast, Australia, 2004.
T.-E. Lee and S.-H. Park, “An extended event graph with negative places and tokens for time window constraints,” IEEE Transactions on Automation Science and Engineering, vol. 2, no. 4, pp. 319-332, October 2005.
M. J. Lopez and S. C. Wood, “Systems of multiple cluster tools: configuration, reliability, and performance,” IEEE Transactions on Semiconductor Manufacturing, vol. 16, no. 2, pp. 170-178, May 2003.
T. Murata, “Petri nets: Properties, analysis and applications,” Proceedings of the IEEE, vol. 77, no. 4, pp. 541-580, April 1989.
T. Nishi and I. Matsumoto, “Petri net decomposition approach to deadlock-free and non-cyclic scheduling of dual-armed cluster tools,” IEEE Transactions on Automation Science and Engineering, vol. 12, no. 1, pp. 281-294, 2015.
Y. Qiao, N. Q. Wu, and M. C. Zhou, “Petri net modeling and wafer sojourn time analysis of single-arm cluster tools with residency time constraints and activity time variation,” IEEE Transactions on Semiconductor Manufacturing, vol. 25, no. 3, pp. 432-446, August 2012.
Y. Qiao, N. Q. Wu, and M. C. Zhou, “A Petri net-based novel scheduling approach and its cycle time analysis for dual-arm cluster tools with wafer revisiting,” IEEE Transactions on Semiconductor Manufacturing, vol. 26, no. 1, pp. 100-110, February 2013.
Y. Qiao, N. Q. Wu, and M. C. Zhou, “Scheduling of dual-arm cluster tools with wafer revisiting and residency time constraints,” IEEE Transactions on Industrial Informatics, vol. 10, no. 1, pp. 286-300, February 2014.
S. Rostami, B. Hamidzadeh, and D. Camporese, “An optimal periodic scheduler for dual-arm robots in cluster tools with residency constraints,” IEEE Transactions on Robotics and Automation, vol. 17, no. 5, pp. 609-618, October 2001.
S. Venkatesh, R. Davenport, P. Foxhoven, and J. Nulman, “A steady-state throughput analysis of cluster tools: dual-blade versus single-blade robots,” IEEE Transactions on Semiconductor Manufacturing, vol. 10, no. 4, pp. 418-424, November 1997.
U. Wikborg and T.-E. Lee, “Noncyclic scheduling for timed discrete event systems with application to single-armed cluster tools using Pareto-optimal optimization,” IEEE Transactions on Automation Science and Engineering, vol. 10, no. 3, pp. 699-710, July 2013.
N. Q. Wu, “Necessary and sufficient conditions for deadlock-free operation in flexible manufacturing systems using a colored Petri net model,” IEEE Transactions on Systems, Man, and Cybernetics, Part C: Applications and Reviews, vol. 29, no. 2, pp. 192-204, May 1999.
N. Q. Wu, C. B. Chu, F. Chu, and M. C. Zhou, “A Petri Net Method for Schedulability and Scheduling Problems in Single-Arm Cluster Tools With Wafer Residency Time Constraints,” IEEE Transactions on Semiconductor Manufacturing, vol. 21, no. 2, pp. 224-237, May 2008.
N. Q. Wu, F. Chu, C. B. Chu, and M. C. Zhou, “Petri Net-Based Scheduling of Single-Arm Cluster Tools With Reentrant Atomic Layer Deposition Processes,” IEEE Transactions on Automation Science and Engineering, vol. 8, no. 1, pp. 42-55, January 2011.
N. Q. Wu, F. Chu, C. B. Chu, and M. C. Zhou, “Petri Net Modeling and Cycle-Time Analysis of Dual-Arm Cluster Tools With Wafer Revisiting,” IEEE Transactions on Systems, Man, and Cybernetics: Systems, vol. 43, no. 1, pp. 196-207, January 2013a.
N. Q. Wu and M. C. Zhou, “Avoiding deadlock and reducing starvation and blocking in automated manufacturing systems,” IEEE Transactions on Robotics and Automation, vol. 17, no. 5, pp. 658-669, October 2001.
N. Q. Wu and M. C. Zhou, System Modeling and Control with Resource-Oriented Petri Nets, New York, N.Y., USA: CRC Press, Taylor & Francis Group, 2009.
N. Q. Wu and M. C. Zhou, “A Closed-Form Solution for Schedulability and Optimal Scheduling of Dual-Arm Cluster Tools With Wafer Residency Time Constraint Based on Steady Schedule Analysis,” IEEE Transactions on Automation Science and Engineering, vol. 7, no. 2, pp. 303-315, April 2010a.
N. Q. Wu and M. C. Zhou, “Colored timed Petri nets for modeling and analysis of cluster tools,” Asian J. Control, vol. 12, no. 3, pp. 253-256, 2010b.
N. Q. Wu and M. C. Zhou, “Schedulability Analysis and Optimal Scheduling of Dual-Arm Cluster Tools With Residency Time Constraint and Activity Time Variation,” IEEE Transactions on Automation Science and Engineering, vol. 9, no. 1, pp. 203-209, January 2012a.
N. Q. Wu and M. C. Zhou, “Modeling, Analysis and Control of Dual-Arm Cluster Tools With Residency Time Constraint and Activity Time Variation Based on Petri Nets,” IEEE Transactions on Automation Science and Engineering, vol. 9, no. 2, pp. 446-454, April 2012b.
N. Q. Wu, M. C. Zhou, F. Chu, and C. B. Chu, A Petri-net-based scheduling strategy for dual-arm cluster tools with wafer revisiting, IEEE Transactions on Systems, Man, & Cybernetics: Systems, vol. 43, no. 5, 1182-1194, 2013b.
J. G. Yi, S. Ding, D. Song, and M. T. Zhang, “Steady-State Throughput and Scheduling Analysis of Multicluster Tools: A Decomposition Approach,” IEEE Transactions on Automation Science and Engineering, vol. 5, no 0.2, pp. 321-336, April 2008.
H. J. Yoon and D. Y. Lee, “Online Scheduling of Integrated Single-Wafer Processing Tools With Temporal Constraints,” IEEE Transactions on Semiconductor Manufacturing, vol. 18, no. 3, pp. 390-398, August 2005.
W. M. Zuberek, “Timed Petri nets in modeling and analysis of cluster tools,” IEEE Transactions on Robotics and Automation, vol. 17, no. 5, pp. 562-575, October 2001.

In semiconductor manufacturing, cluster tools that adopt single-wafer processing technology are widely used in wafer processing for better quality control and lead time reduction. A typical cluster tool is configured with several process modules (PMs), a wafer handling robot, and two loadlocks for wafer loading and unloading. According to the number of arms equipped for the robot, a cluster tool is called a single-arm or dual-arm cluster tool as shown in FIG. 1.

With two loadlocks, a cluster tool can operate uninterruptedly under steady state. Studies for modeling and performance evaluation of cluster tools under the steady state have been extensively done [Chan et al., 2011; Ding et al., 2006; Kim et al., 2012 and 2015; Jung an Lee, 2012; Nishi and Matsumoto, 2015; Venkatesh et al., 1997; Wikborg and Lee, 2013; Yi et al., 2008; and Zuberek, 2001]. Under the steady state, if wafer processing time dominates the process, a cluster tool is called to be process-bound, while it is called to be transport-bound if the robot is always busy. According to [Kim et al. 2003], the time taken for the robot to move from one step to another can be treated as the same and is much shorter than the wafer processing time. In this case, a cluster tool operates in the process-bound region such that a backward scheduling strategy is optimal for a single-arm tool [Lee et al., 2004, and Lopez et al., 2003] and a swap scheduling strategy is optimal for a dual-arm tool [Venkatesh et al., 1997].

The aforementioned studies are conducted under the assumption that there is no constraint on the wafer sojourn time in a PM. For some wafer fabrication processes, such as low-pressure chemical-vapor deposition, there are strict wafer residency time constraints, which requires that a wafer should be removed from a PM within a given time after it is processed [Kim, et al., 2003, Lee and Park., 2005, Rostami et al. 2001, Yoon and Lee, 2005, Qiao et al., 2012, Wu and Zhou, 2012a, Wu and Zhou, 2012b]. Without any intermediate buffer between the PMs, the scheduling problem of tools with residency time constraints is very complex and challenging. The scheduling problem of cluster tools with wafer residency time constraints is studied and techniques are developed to find an optimal periodical schedule in [Kim et al., 2003, Lee and Park, 2005, Hamidzadeh and Camporese, 2001]. To improve computational efficiency, this problem is further tackled for both single-arm and dual-arm cluster tools by using schedulability analysis and closed-form solution methods are presented in [Wu et al., 2008 and Wu and Zhou, 2010a]. They present a so called robot waiting method. By this method, a schedule is parameterized by robot waiting time and can be obtained by setting the robot waiting time.

The above-mentioned work is done for wafer fabrication processes with no wafer revisiting. Some wafer fabrication processes, such as the atomic layer deposition (ALD) process, require that a wafer should be processed by some processing steps more than once, leading to a revisiting process. With wafer revisiting, a cluster tool is no longer a flow-shop and methods developed for scheduling tools without wafer revisiting are not applicable. As shown in [Wu et al., 2013a], for a dual-arm cluster tool with wafer revisiting, a three-wafer cyclic schedule is obtained if a swap strategy is applied and the system may never reach a steady state. Furthermore, with wafer revisiting, a cluster tool is deadlock-prone, which further complicates the scheduling problem of a cluster tool. Lee and Lee, [2006] pioneer the study of scheduling single-arm cluster tools with wafer revisiting. They model the system by a Petri net and the scheduling problem is then formulated as a mixed integer programming to find an optimal periodical schedule. Following the work in [Lee and Lee, 2006], Wu et al., [2011] develop a maximal permissive deadlock-avoidance policy for a single-arm cluster tool with the ALD process. Based on the model and the control policy, analytical expressions are proposed to find the optimal schedule. For dual-arm cluster tools with wafer revisiting, a method is presented to obtain a two-wafer cyclic schedule that is better than a three-wafer schedule. Since a one-wafer cyclic schedule is easy to implement and control, this problem is further investigated in [Qiao et al., 2013] and a modified swap strategy is proposed to obtain a one-wafer periodical schedule. It is shown that such a schedule can reach the lower bound of cycle time. The scheduling problem of dual-arm cluster tools with both wafer revisiting and residency time constraints is studied and effective techniques are proposed to find an optimal one-wafer cyclic schedule in [Qiao et al., 2014].

However, to the best knowledge of the inventors, up to now, no study has been done on the scheduling problem of single-arm cluster tools with both wafer revisiting and wafer residency time constraints. Notice that it is more difficult to avoid deadlock for a single-arm cluster tool with wafer revisiting than for a dual-arm tool. Thus, scheduling single-arm cluster tools with both wafer revisiting and wafer residency time constraints is more complicated.

There is a need in the art for a method for scheduling time constrained single-arm cluster tools with wafer revisiting.

### SUMMARY OF THE INVENTION

With wafer revisiting, a single-arm cluster tool is deadlock-prone and it is very difficult to schedule such a tool to satisfy wafer residency time constraints. Thus, scheduling single-arm cluster tools with wafer revisiting and residency time constraints is very challenging. Up to now, there are studies on scheduling single-arm cluster tools with wafer revisiting or wafer residency time constraints, but not both. The present invention conducts a study on scheduling single-arm cluster tools with both of them for the ALD process. Based on a p-backward strategy, a Petri net is developed to model the process. With the model, analysis on the existence of a feasible schedule is done and schedulability conditions are established. By the proposed method, a schedule is parameterized as robot waiting time. Hence, if a feasible schedule exists, a schedule can be found very efficiently by simply setting the robot waiting time. The obtained schedule is shown to be optimal in terms of productivity.

An aspect of the present invention is to provide a method for scheduling time constrained single-arm cluster tools with wafer revisiting.

According to an embodiment of the present invention, a computer-implemented method for scheduling a cluster tool, the cluster tool comprising a single-arm robot for wafer handling, a wafer-processing system comprising four process modules including PM₁, PM₂, PM₃, and PM₄, each for performing a wafer-processing step with a wafer residency time constraint where the ith process module, i ε{1, 2, . . . , 4}, is used for performing Step i of the wafer-processing steps for each wafer, and a wafer flow pattern having (PM₁, (PM₂, PM₃)^{h}, PM₄) with (PM₂, PM₃)^{h} being the revisiting process and h≧2, the method comprising:

obtaining, by a processor, a lower bound π_{iL} of a production cycle of Step i, iε{1, 2, . . . 4}, as follows:

π_{1L}=α₁+3μ+4λ;

π_{2L}=2α₂+α₃+5μ+8λ;

π_{3L}=2α₃+α₂+5μ+8λ; and

π_{4L}=α₄+3μ+4λ;

obtaining, by a processor, an upper bound π_{iU} of a production cycle of Step i, iε{1, 2, . . . 4}, as follows:

π_{1U}=α₁+3μ+4λ;

π_{2U}=2α₂+α₃+5μ+8λ;

π_{3U}=2α₃+α₂+5μ+8λ; and

π_{4U}=α₄+3μ+4λ;
obtaining, by a processor, a maximum lower bound π_{Lmax} as follows:

π_{Lmax}=max{π_{iL},iε [symbol] ₄};
obtaining, by a processor, a minimum upper bound π_{Umin} as follows:

π_{Umin}=min{π_{iU},iε [symbol] ₄};
determining, by a processor, a robot task time ωᵢ in a cycle as follows:

η₁=14λ+12μ+α₂+α₃;
determining, by a processor, a robot waiting time at ωᵢ of Step i as follows:

if [π_{1L},π_{1U}]∩[π_{2L},π_{2U}]∩[π_{3L},π_{3U}]∩[π_{4L},π_{4U}]≠Ø and η₁<π_{Lmax}, then setting ω₀=ω₁=ω₂=ω₃=0, and setting ω₄=π_{Lmax}−η₁;

else if [π_{1L},π_{1U}]∩[π_{2L},π_{2U}]∩[π_{3L},π_{3U}]∩[π_{4L},π_{4U}]≠Ø and π_{Lmax}≦η₁≦π_{Umin}, then setting ω₀=ω₁=ω₂=ω₃=0;

else if [π_{1L},π_{1U}]∩[π_{2L},π_{2U}]∩[π_{3L},π_{3U}]∩[π_{4L},π_{4U}]=Ø and π_{Lmax}≦η₁≦π_{Umin}, then setting ωᵢ,iεΩ₃ by

$${ω}_{i - 1} = \{ \begin{matrix}0 , & i ∈ F \\ {π}_{Lmax} - {α}_{i} - {δ}_{i} - 4 λ - 3 μ , & i ∈ E ⋂ \{ 1 , 4 \} \\ {π}_{Lmax} - 2 {α}_{2} - {δ}_{2} - {α}_{3} - 5 μ - 8 λ , & i ∈ E ⋂ \{ 2 \} \\ {π}_{Lmax} - 2 {α}_{3} - {δ}_{3} - {α}_{2} - 5 μ - 8 λ , & i ∈ E ⋂ \{ 3 \}\end{matrix} \\ and setting {ω}_{4} = {π}_{Lmax} - {η}_{1} - {\sum }_{i = 0}^{3} {ω}_{i} ;$$

wherein:
αᵢ, iε [symbol] ₄, is a time that a wafer is processed in the ith process module;
δᵢ, iε [symbol] ₄, is a longest time that a wafer stays in the ith process module after being processed;
λ is a time that a wafer is loaded or unloaded by the robot from Step i;
μ is a time that a wafer is moved by the robot from Step i to Step j;
E={i|π_{iU}<π_{Lmax}, iε [symbol] ₄}; and
F= [symbol] ₄\E.

### BRIEF DESCRIPTION OF THE DRAWINGS

Embodiments of the present invention are described in more detail hereinafter with reference to the drawings, in which:

FIG. 1 depicts cluster tools: (a) single-arm robot and (b) dual-arm robot; and

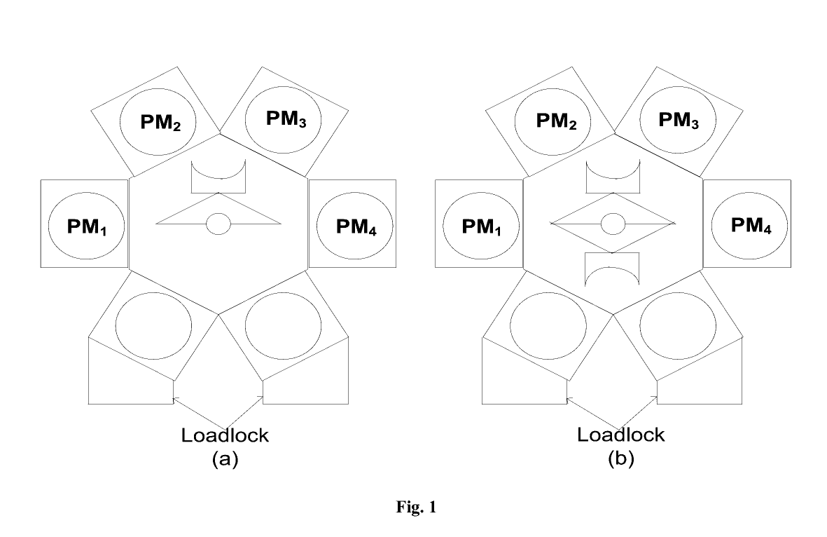

FIG. 2 depicts a PN model for the system with wafer flow pattern (PM₁, (PM₂, PM₃)^{h}, PM₄).

### DETAILED DESCRIPTION

In the following description, a method for scheduling time constrained single-arm cluster tools with wafer revisiting is set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The aim of the present invention is to cope with this challenging problem for a single-arm cluster tool. The problem is modeled by a Petri net by using a p-backward strategy explained later. With the model, analysis on the existence of a feasible schedule is carried out and conditions under which a schedule exists are presented. If it is schedulable, a schedule is very efficiently obtained by simply setting the robot waiting time. The obtained schedule is shown to be optimal in terms of cycle time.

In Section A, the present invention develops the PN model for the system. Based on it, Section B carries out the schedulability analysis, establishes the schedulability conditions, and presents scheduling algorithms to obtain the optimal schedule. Illustrative examples are used to demonstrate the proposed method in Section C.

### A. MODELING BY PETRI NET

Petri nets (PNs) are recognized as a powerful tool for dealing with concurrent activities and resource allocation. They are widely used for modeling, analysis, and control of manufacturing systems [Wu et al., 2008a, and 2011, 2013; and Kim et al., 2003 and 2013]. The present invention adopts PN to model the dynamic behavior of a single-arm cluster tool with both wafer residency time constraints and wafer revisiting.

### A.1 Finite-Capacity PN

Scheduling a cluster tool is to effectively allocate its limited resources to tasks. To do so, the present invention adopts the resource-oriented PN (ROPN) to model the system. It is a finite capacity PN and its basic concept is based on [Murata, 1989, Wu, 1999; and Wu and Zhou, 2001, and 2009]. It is denoted as PN=(P, T, I, O, M, K), where P=(p₁, p₂, . . . , pₘ) and T=(t₁, t₂, . . . , tₙ) are finite sets of places and transitions with P∩T=Ø and P∪T≠Ø; I: P×T→N={0, 1, 2, . . . } and O: P×T→N describe the relation from P to T and T to P, respectively; M: P→N is a marking with M(p) being the number of tokens in place p and M₀ being the initial marking; K: P→{1, 2, 3, . . . } is a capacity function with K(p) representing the maximum number of tokens that can be held by p at a time.

Let ^{•}t={p: pεP and I(p, t)>0} be the preset of transition t and t^{•}={p: pεP and O(p, t)>0} be its postset. Similarly, p's preset ^{•}p={tεT: O(p, t)>0} and postset p^{•}={tεT: I(p, t)>0}. Then, the transition enabling and firing rules are defined as follows.

Definition 2.1: A transition tεT in a finite capacity PN is said to be enabled if following conditions are satisfied.

M(p)≧I(p,t),∀pεP (2.1)

K(p)≧M(p)−I(p,t)+O(p,t),∀pεP (2.2)

By Definition 2.1, when (2.1) is met, t is said to be process-enabled, and when (2.2) is met, t is said to be resource-enabled. Thus, t is enabled if it is both process and resource-enabled.

An enabled tεT at marking M can fire. The firing oft transforms the PN from M to M′ according to

M′(p)=M(p)−I(p,t)+O(p,t),∀pεP (2.3)

### A.2 Modeling Activity Sequences

In wafer fabrication, ALD is a typical revisiting process and, as done in [Wu et al., 2011], the present invention focuses on the ALD process. In ALD, a wafer visits Step 1 first and then it goes to Steps 2 and 3 sequentially for processing. After being processed by Step 3, it goes back to Step 2 and the Step 3. This process is repeated for several times. To control the quality, every time the wafer visits Steps 2 and 3, the exact same processing environment is required. To ensure the processing environment requirement, each step is configured with only one PM. One assumes that PM, is configured for Step i. Thus, as presented in [Wu et al., 2011], the wafer flow pattern for this process can be denoted as (PM₁, (PM₂, PM₃)^{h}, PM₄) with (PM₂, PM₃)^{h} being the revisiting process and h≧2. For the simplicity of presentation, the present invention focuses on the case when h=2. Notice that the obtained results with h=2 can be extended to cases with h>2. Then, a single-arm cluster tool with both wafer residency time constraints and wafer revisiting is modeled by an ROPN as follows.

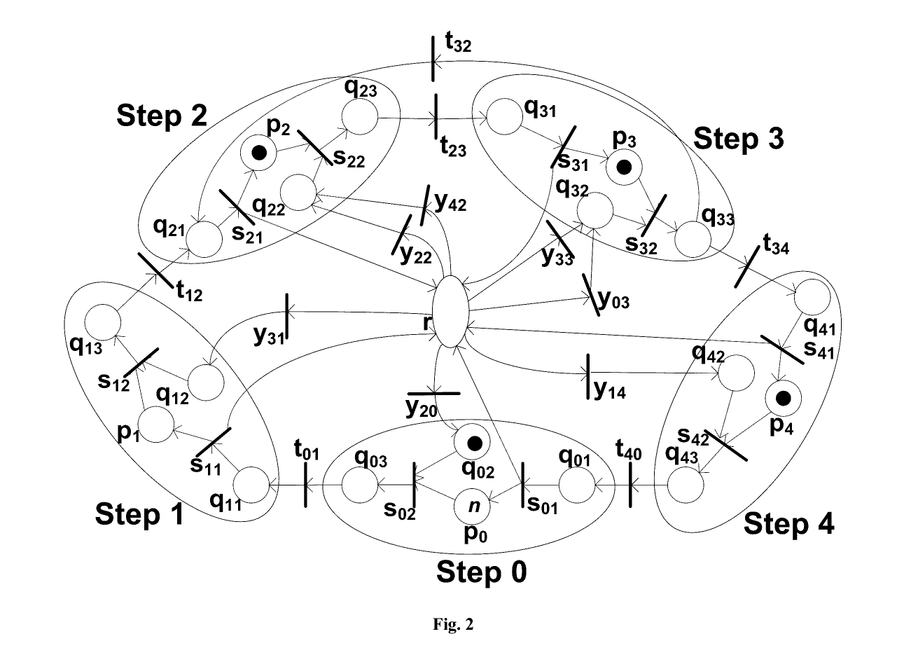

Let Nₙ{1, 2, 3, . . . , n} and Ωₙ=Nₙ∪{0}. As shown in FIG. 2, timed place pₙ, nεN₄, models the PM for Step n with K(pₙ)=1 representing that there is only one PM. The loadlocks are treated as a processing step with the processing time being zero. They are modeled by p₀ with K(p₀)=∞ representing that the loadlocks can hold all wafers in a tool. Timed place qₙ₂ with K(qₙ₂)=1, nεΩ₄, models the robot waiting before unloading a wafer from pₙ. Non-timed places qₙ₁ and qₙ₃ with K(qₙ₁)=K(qₙ₃)=1, nεΩ₄, are used to connect two neighboring steps. Place r with K(r)=1 models the robot (R). When M(r)=1, the robot is idle and ready for performing a task.

With the resources in the system being modeled, transitions are used to model the material flows. Timed transition tᵢⱼ, i, jεΩ₄, models the activity that the robot moves from pᵢ to pⱼ with a wafer being carried. Timed transition yᵢⱼ, i, jεΩ₄, models the activity that the robot moves from pᵢ to pⱼ without carrying a wafer. Transitions sₙ₁ and sₙ₂ represent the robot tasks that load and unload a wafer into and from pₙ, nεΩ₄, respectively. By doing so, the structure of the model is formed.

With the developed PN structure, by putting a V-token representing a virtual wafer, the initial marking M₀ is set as follows. Set M₀(pᵢ)=1, iεN₄\{1}, M₀(p₁)=0, and M₀(p₀)=n to indicate that, there are always wafers in the loadloacks to be processed; M₀(r)=0; M₀(qᵢⱼ)=0, iε [symbol] ₄ and jεΩ₃, and M₀(q₀₂)=1, indicating that the robot is waiting at the loadlocks for unloading a wafer there.

With wafer revisiting process, there are two ways for a token in q₃₃ to go, one is to q₂₁ by firing t₃₂ and the other is to q₄₁ by firing t₃₄, leading to a conflict. To eliminate such a conflict, colors are introduced to the model to form a colored PN as follows.

Definition 2.2: Transition tᵢ in the PN is defined to have a unique color C(tᵢ)=cᵢ.

By Definition 2.2, the color of t₃₂ and t₃₄ are C₃₂ and c₃₄, respectively. Let W_{d}(g) be the d-th wafer released into the system and being processed for the g-th time by a PM. Then, one can define the color of a token as follows.

Definition 2.3: Define the color of a token W_{d} in q₃₃ as C(q₃₃, W_{d})=c₃, if it will go to step j for processing when it leaves q₃₃.

By Definition 2.3, one has C(q₃₃, W_{d}(q))=C(t₃₂)=e₃₂, 1≦q<h, and (q₃₃, W_{d}(h))=C(t₃₄)=c₃₄. Notice that, in the model, only q₃₃ has multiple output transitions. Hence, by Definitions 2.2 and 2.3, conflict is eliminated. Besides conflict, deadlock is an important issue for operating a single-arm tool with wafer revisiting. To avoid deadlock, one presents a control policy by the following definition.

Definition 2.4: At any marking M, transitions y₂₀ is control-enabled only if the transition firing sequence t₁₂→s₂₁ has just performed; y₀₃ is control-enabled only if s₀₁ has just fired; y₁₄ is control-enabled only if s₁₁ has just fired; y₄₂ is control-enabled only if s₄₁ has just fired; y₂₂ is control-enabled only if the transition firing sequence t₃₂→s₂₁ has just performed; y₃₃ is control-enabled only if the transition firing sequence y₄₂→s₂₂→t₂₃→s₃₁ has just fired; and y₃₁ is enabled only if the transition firing sequence t₃₂→s₂₁→y₂₂→s₂₂→t₂₃→s₃₁ has just performed.

Let M=(S₁, S₂, S₃, S₄) represent the marking of the system, where Sᵢ represents the state at Step i, iεN₄. Sᵢ={W_{d}(g)} representing that the d-th wafer is being processed at Step i for the g-th time, or {V_{d}(g)} representing that the d-th virtual wafer is being processed at Step i for the g-th time, or {null} representing that Step i is idle. In this way, as above discussed, one has M₀=({null}, {V₃(1)}, {V₂(2)}, {V₁(1)}). Then, by Definition 2.4, at M₀, the only enabled transition is s₀₂. After s₀₂ fires, R performs task sequence <t₀₁→s₁₁→y₁₄→s₄₂→t₄₀→s₀₁→y₀₃→s₃₂→t₃₄ (according to its color)→s₄₁→y₄₂→s₂₂→t₂₃→s₃₁→y₃₃ waiting for the completion of the wafer at Step 3→s₃₂→t₃₂ (according to its color)→s₂₁→y₂₂→waiting for the completion of the wafer at Step 2→s₂₂→t₂₃→s₃₁→y₃₁→s₁₂→t₁₂→s₂₁→y₂₀→s₀₂> such that a cycle is completed and there is no deadlock. This implies that, by the control policy given in Definition 2.4, the model is deadlock-free. It can be verified that this control policy is necessary and sufficient.

### A.3 Task Time Modeling

In order to schedule the process, it is necessary to model the time taken for performing each activity. From the PN model, both transitions and places represent tasks that take time. As done in [Lee and Lee, 2006; and Wu et al, 2011], one assumes that the time taken for each activity is deterministic and known. The time taken for the robot to move from Step i to j, i≠j, with or without holding a wafer is assumed to be same [Kim et al., 2003] and denoted by μ, i.e., it takes μ time units to fire tᵢⱼ and yᵢⱼ. Note that in the revisiting process, after loading a wafer into p₃/p₂, the robot waits there for the completion of the wafer and it does nothing and takes no time. Similarly, the time taken for the robot to unload (firing sᵢ₂)/load (firing sᵢ₁) a wafer from/into a step is assumed to be the same as well and it is denoted by λ. The time taken for processing a wafer in pᵢ, iεΩ₄, is αᵢ with αᵢ>0, i≅0, and α₀=0.

Let δᵢ be the longest time for which a wafer can stay in a PM at Step i without being scrapped after being processed. Then, with wafer residency time constraints, the wafer sojourn time at Step i should be within [αᵢ, αᵢ+δᵢ], i.e., a token should stay in PMᵢ for at least αᵢ time units and no more than αᵢ+δᵢ time units. One uses τᵢ and τ₄ to denote the wafer sojourn time at Steps 1 and 4, respectively; and τ₂ⱼ and τ₃ⱼ, jεN₂ to denote the wafer sojourn time for the j-th visiting Steps 2 and 3, respectively. Notice that no wafer residency time constraint is imposed on Step 0. The symbols and explanation are summarized in Table I.

TABLE I
TIME DURATIONS ASSOCIATED WITH TRANSITIONS AND PLACES.

| | Transition | | |
|---|---|---|---|
| Symbol | or place | Actions | Allowed time duration |
| λ | sᵢ₁ ∈ T | Robot loads a wafer into Step i, i∈Ω₄ | λ |
| λ | sᵢ₂ ∈ T | Robot unloads a wafer from Step i, i∈Ω₄ | λ |
| μ | tᵢⱼ∈ T | Robot moves from Steps i to j with | μ |
| | | a wafer carried, i, j∈Ω₄ | |
| μ | yᵢⱼ∈ T | Robot moves from Steps i to j without | If i≠j, fixed as μ, |
| | | carrying a wafer, i, j∈Ω₄ | otherwise, 0 |
| τ₁ and | p₁ and | A wafer is being processed and waiting | [αᵢ, αᵢ + δᵢ] |
| τ₄ | p₄ ∈ P | in p₁ and p₄ | |
| τ₂ⱼ and | p₂ⱼ and p₃ⱼ | A wafer being processed and waiting in | [αᵢ, αᵢ + δᵢ] |
| τ₃ⱼ | ∈P | p₂ⱼ and p₃ⱼ, j = 1, 2 | |
| ωᵢ | qᵢ₂∈P | Robot waits before unloading a wafer | ≧0 |
| | | from PMᵢ, | |
| | | i∈Ω₄ | |
| ωᵢ | qᵢ₃ ∈ P | Robot waits after unloading a wafer | 0 |
| | | from PMᵢ, i∈Ω₄ | |
| ωᵢ | qᵢ₁ ∈ P | Robot waits before loading a wafer from | 0 |
| | | PMᵢ, i∈Ω₄ | |

From the above analysis, for a single-arm cluster tool with wafer revisiting and residency time constraints, according to [Wu et al., 2008; and Wu and Zhou, 2010b], one has the following schedulability definition.

Definition 2.5 [Wu et al., 2008; and Wu and Zhou, 2010b]: Given the wafer sojourn time interval [αᵢ, αᵢ+δᵢ] for Step i, iε [symbol] ₄, if there exists a schedule such that whenever sᵢ₂, iε{1, 4}, fires, αᵢ≦τᵢ≦αᵢ+δᵢ holds, and whenever sᵢ₂, iε{2, 3}, fires, αᵢ≦τᵢⱼ≦αᵢ+δᵢ, +jεN₂, holds, then, a single-arm cluster tool with wafer revisiting and residency time constraints is schedulable.

With the PN model, one discusses the scheduling problem next.

### B. SYSTEM SCHEDULING

In [Wu et al., 2011], a p-backward strategy is proposed to schedule a single-arm cluster tool for the ALD process without taking wafer residency time constrains into account. Based on the PN model, the present invention adopts this strategy to explore the schedulability and scheduling problem of a single-arm cluster tool with residency time constraints for the ALD process. If schedulable, efficient algorithm is developed to find an optimal schedule.

### B.1 P-Backward Scheduling

To make the scheduling analysis, one needs to present the p-backward scheduling strategy for a single-arm cluster tool with wafer revisiting. Based on the PN model, one shows how a p-backward strategy works. Since a single-arm cluster tool with wafer revisiting is deadlock-prone, to avoid deadlock, the system must start from a proper state. One assumes that the system starts from Marking M₁=({null}, {W₃(1)}, {W₂(2)}, {W₁(1)}) and, at the same time, the robot is idle, or M₁(r)=1. Notice that this marking is consistence with M₀ that is set in the last section and can be reached by applying a p-backward strategy. By starting from M₁ with a p-backward strategy being applied, the system evolves as follows.
Step 1: Transition firing sequence σ₁=<firing y₂₀→s₀₂→t₀₁→s₁₁> (the robot goes to the loadlocks from PM₂→waits in q₀₂→unloads W₄ there moves to PM₁→loads W₄ into PM₁) is performed such that W₄(1) is put into Step 1. By doing so, it transforms the system from M₁ to M₂=({W₄(1)}, {W₃(1)}, {W₂(2}, {W₁(1)}).
Step 2: Transition firing sequence σ₂=<firing y₁₄→waiting in q₄₂→s₄₂→t₄₀→s₀₁> is performed such that M₃=({W₄(1)}, {W₃(1)}, {W₂(2)}, {null}) is reached.
Step 3: Transition firing sequence σ₃=<firing y₀₃→waiting in q₃₂→s₃₂→t₃₄→s₄₁> is performed such that M₄=({W₄(1)}, {W₃(1)}, {null}, {W₂(1)}) is reached.
Step 4: Transition firing sequence σ₄=<firing y₄₂→waiting in q₂₂→s₂₂→t₂₃→s₃₁> is performed such that M₅=({W₄(1)}, {null}, {W₃(1)}, {W₂(1)}) is reached.
Step 5: Transition firing sequence σ₅=<firing y₃₃→waiting q₃₂→s₃₂→t₃₂→s₂₁> is performed such that M₆=({W₄(1)}, {W₃(2)}, {null}, {W₂(1)}) is reached.
Step 6: Transition firing sequence σ₆=<firing y₂₂→waiting q₂₂→s₂₂→t₂₃→s₃₁> is performed such that M₇=({W₄(1)}, {null}, {W₃(2)}, {W₂(1)}) is reached.
Step 7: Transition firing sequence σ₇=<firing y₃₁→waiting in q₁₂→s₁₂→t₁₂→s₂₁> is performed such that M₈=({null}, {W₄(1)}, {W₃(2)}, {W₂(1)}) is reached.

Note that Marking M₈ is equivalent to M₁ in the sense of dynamic behavior of PN. Hence, by transforming M₁ to M₈, a cycle is completed. This is what a p-backward strategy does.

### B.2 Cycle Time Analysis

With the above discussion, one can analyze the cycle time for the system. Let φⱼ be the time taken for the robot to perform σⱼ, jεN₇. Then, from the time modeling, one can easily obtain φ₁=μ+ω₀+λ+μ+λ=2μ+2λ+ω₀. Similarly, for σ₂₋₇, one has φ₂=2μ+2λ+ω₄, φ₃=2μ+2λ+ω₃; φ₄=2μ+2λ+ω₂; φ₅=μ+2λ+α₃; φ₆=μ+2λ+α₂; and φ₇=2μ+2λ+ω₁.

Since σ₁₋₇ form a robot cycle, the robot cycle time is

$$η = {\sum }_{i = 1}^{7} {ϕ}_{i} = ( 14 λ + 12 μ + {a}_{2} + {a}_{3} ) + {\sum }_{i = 0}^{4} {ω}_{i} = {η}_{1} + {η}_{2} \qquad ( 3.1 )$$

where η₁=14λ+12μ+α₂+α₃ is the robot task time in a cycle and

$${η}_{2} = {\sum }_{i = 0}^{4} {ω}_{i}$$

is the robot waiting time in a cycle. Notice that η₁ is constant and known in advance and ω₀₋₄ in η₂ should be determined by a schedule.

Based on the fact that the cycle time of the entire system must be equal to the robot cycle time [Wu. et. al., 2008], with the robot cycle time obtained, one can analyze the wafer sojourn time at each Step. It follows from the above analysis that the wafer sojourn time at Step 1 is equal to the robot cycle time minus the time taken for performing σ₁ and the time for firing s₁₂, t₁₂, and s₂₁ in σ₇, i.e., one has

τ₁=η−(2μ+2λ+ω₀)−(μ+2λ)=η−3μ−4λ−ω₀ (3.2)

Similarly, for Step 4, one has

τ₄=η−3λ−4λ−ω₃ (3.3)

For Step 2, the sojourn time taken for a wafer to visit the step for the first time is different from that for a wafer to visit the step for the second time. One uses τ₂₁ and τ₂₂ to denote them, respectively. It follows from the above transition firing analysis that τ₂₁ is equal to the robot cycle time minus the time taken for σ₅₋₇ and the time taken for firing s₂₂, t₂₃, and s₃₁ in σ₄. Thus, one has

$$\begin{matrix}{τ}_{21} = η - ( {ϕ}_{5} + {ϕ}_{6} + {ϕ}_{7} ) - ( λ + μ + λ ) \\ = η - ( μ + 2 λ + {α}_{3} ) - ( μ + 2 λ + {α}_{2} ) - ( 2 μ + 2 λ + {ω}_{1} ) - \\ ( 2 λ + μ ) \\ = η - 5 μ - 8 λ - {α}_{3} - {α}_{2} - {ω}_{1}\end{matrix} \qquad ( 3.4 )$$

When a wafer visits Step 2 for the second time, the robot loads it into PM₂ and waits here for its completion. Thus, one has

τ₂₂=α₂ (3.5)

Similarly, one can calculate the wafer sojourn time for Step 3 and one has

τ₃₁=α₃ (3.6)

τ₃₂=η−5μ−8λ−α₃−α₂−ω₂ (3.7)

With wafer residency time constraints, to make a schedule feasible, the cycle time for each step should be in a permissive range. Thus, one analyzes such a range for each step as follows. For Step 1, it follows from the above analysis that, to complete a wafer requires three robot moving tasks between steps (t₀₁, t₁₂, and y₂₁), two wafer unloading tasks (s₀₂ and s₁₂), and two wafer loading tasks (s₁₁ and s₂₁). Thus, with the wafer staying time in Step 1, the time taken for this process is

θ₁=τ₁+3μ+4λ+ω₀ (3.8)

To be feasible, one has τ₁ε[α₁, α₁+δ₁]. Hence, the permissive shortest cycle time at Step 1 is

θ_{1S}=α₁+3μ+4λ+ω₀ (3.9)

and the permissive longest cycle time at Step 1 is

θ_{1L}=α₁+δ₁+3μ+4λ+ω₀ (3.10)

Similarly, the cycle time for completing a wafer at Step 4 is

θ₄=τ₄+3μ+4λ+ω₃ (3.11)

The permissive shortest cycle at Step 4 is

θ_{4S}=α₄+3μ+4λ+ω₃ (3.12)

and the permissive longest cycle time at Step 4 is

θ_{4L}=α₄+δ₄+3μ+4λ+ω₃ (3.13)

For Step 2 in the revisiting process, one analyzes the wafer cycle as follows. By firing s₂₁ (σ₈=<s₂₁ (λ)>), a wafer is loaded into Step 2 for processing for the first time, which is followed by transition firing sequence σ₉=(y₂₀→s_{O2}→t₀₁→s₁₁→y₁₄→s₄₂→t₄₀→s₀₁→y₀₃→s₃₂→t₃₄→s₄₁→y₄₂). During the time for performing σ₉, the wafer just loaded into Step 2 is being processed. Hence, the time taken for performing σ₉ is the wafer sojourn time for the first visiting Step 2, i.e., τ₂₁. Then, transition firing sequence σ₁₀=<t₂₃ (μ)→s₃₁ (λ)→y₃₃ (0)→waiting for the completion at Step 3 (α₃)→s₃₂ (λ)→t₃₂ (μ)→s₂₁ (λ) (loading the wafer into Step 2 to be processed for the second time)→y₂₂ (0)→waiting for the completion of the wafer at Step 2 (τ₂₂)→s₂₂ (λ)→t₂₃(μ)→s₃₁(λ)→y₃₁(μ)→waiting in q₁₂ (ω₁)→s₁₂(λ)→t₁₂ (μ)> is performed. By performing σ₈₋₁₀, a cycle is completed at Step 2. Thus, the time taken for completing a wafer at Step 2 is

θ₂=τ₂₁+τ₂₂+α₃+5μ+8λ+ω₁ (3.14)

With τ₂₁ε[α₂, α₂+δ₂] and τ₂₂=α₂, the permissive shortest cycle at Step 2 is

θ_{2S}=α₂+α₂+α₃+5μ+8λ+ω₁=2α₂+α₃+5μ+8λ+ω₁ (3.15)

and the permissive longest cycle time at Step 2 is

θ_{2L}=α₂+δ₂+α₂+α₃+5μ+8λ+ω₁=2α₂+δ₂+α₃+5μ+8λ+ω₁ (3.16)

For Step 3, similar to Step 2, one analyzes the process as follows. One has the following transition firing sequence σ₁₁=<s₃₁ (a wafer is loaded into Step 3 to be processed for the first time, λ)→y₃₃ (0)→waiting for the completion of the wafer at Step 3 (τ₃₁)→s₃₂ (λ)→t₃₂ (μ)→s₂₁ (λ)→y₂₂ (0)→waiting for the completion of the wafer at Step 2 (α₂)→s₂₂ (λ)→t₂₃ (μ)→s₃₁ (λ)>. Then, transition firing sequence σ₁₂=<y₃₁→s₁₂→t₁₂→s₂₁→y₂₀→s₀₂→t₀₁→s₁₁→y₁₄→s₄₂→t₄₀→s₀₁→y₀₃> is performed. During the time for performing σ₁₂, a wafer for its second visiting of Step 3 is completed. Thus, the time taken for doing so is τ₃₂. Finally, to complete a cycle, transition firing sequence σ₁₃=<s₃₂ (λ)→t₃₄(μ)→s₄₁(λ)→y₄₂(μ)→waiting in q₂₂ (ω₂)→s₂₂(λ)→t₂₃ (μ)> is performed. Thus, the cycle time for Step 3 is

θ₃=τ₃₁+τ₃₂+α₂+5μ+8λ+ω₂ (3.17)

With τ₃₁=α₃ and τ₃₂ε[α₃, α₃+δ₃], the permissive shortest cycle at Step 3 is

θ_{3S}=2α₃+α₂+5μ+8λ+ω₂ (3.18)

and the permissive longest cycle time at Step 3 is

θ_{3L}=2α₃+δ₃+α₂+5μ+8λ+ω₂ (3.19)

With the above timeliness analysis, one discusses the scheduling problem next. Notice that the above derived expressions are functions of robot waiting time. Hence, the scheduling problem is to decide the robot waiting time ωᵢ's to obtain a schedule if it exists.

### B.3 Schedulability and Scheduling Algorithm

Let θ be the production cycle of the system. Then, the production rate for all the steps must be θ. Also, the robot cycle should be equal to the production rate too, i.e., one has

θ=θ₁=θ₂=θ₃=θ₄=η (3.20)

Based on the above analysis, to make (3.20) hold, one needs to decide ωᵢ's in η₂. Also, to schedule a cluster tool, the production rate should be maximized, which requires to minimize η₂. Furthermore, with wafer residency time constraints, schedule feasibility is essential. To be feasible, a schedule should ensure that θᵢ is in an acceptable interval. Let π_{iL} and π_{iU} denote the lower and upper bounds of θᵢ. It follows from the above analysis that when ω₀=ω₁=ω₂=ω₃=ω₄=0, θ_{iS} and θ_{iL} are the lower and upper bounds of θᵢ, respectively. Thus, by removing the robot waiting time from (3.9), (3.10), (3.12), (3.13), (3.15), (3.16), (3.18), and (3.19), one has the following lower and upper bounds of θᵢ.

π_{1L}=α₁+3μ+4λ (3.21)

π_{1U}=α₁+δ₁+3μ+4λ (3.22)

π_{2L}=2α₂+α₃+5μ+8λ (3.23)

π_{2U}=2α₂+δ₂+α₃+5μ+8λ (3.24)

π_{3L}=2α₃+α₂+5μ+8λ (3.25)

π_{3U}=2α₃+δ₃+α₂+5μ+8λ (3.26)

π_{4L}=α₄+3μ+4λ (3.27)

π_{4U}=α₄+δ₄+3μ+4λ (3.28)

Let π_{Lmax}=max {π_{iL},iεN₄} and π_{Umin}=min{π_{iU}, iεN₄}, one has the following lemma.

Lemma1: If η₁>π_{Umin}, the system is not schedulable.

Proof:

It follows from the above discussion that θ=η≧η₁. When η=η₁, one has ω₀ω₁=ω₂=ω₃=ω₄=0. In this case, if π_{Umin}=π_{kU}, kε{1, 4}, by (3.2) and (3.3), one has τₖ=η₁−3μ−4λ>π_{kU}−3μ−4λ=αₖ+δₖ+3μ+4λ−3μ−4λ=αₖ+δₖ. This implies that the wafer residency time constraints are violated for Step k, kε{1, 4}. If π_{Umin}=π_{2U}, by (3.4), one has τ₂₁=η₁−5μ−8λ−α₃−α₂>π_{2U}−5μ−8λ−α₃−α₂=2α₂+δ₂+α₃+5μ+8λ−5μ−8λ−α₃−α₂=α₂+δ₂. Hence, the wafer residency time constraints are violated for Step 2. If π_{Umin}=π_{3U}, by (3.4), one has τ₃₂=η₁−5μ−8λ−α₃−α₂>π_{3U}−5μ−8λ−α₃−α₂=2α₃+δ₃+α₂+5μ+8λ−5μ−8λ−α₃−α₂=α₃+δ₃. The wafer residency time constraints are violated for Step 3.

$${η}_{2} = η - {η}_{1} = {\sum }_{i = 0}^{4} {ω}_{i}$$

Then, one discusses the case when η>η₁. In this case, one has and ωᵢ≦η−η₁, ∀iεΩ₄. If π_{Umin}=π_{kU}, kε{1, 4}, by (3.2) and (3.3), one has τₖ=η−3μ−4λ−ωₖ₋₁≧3μ−4λ−(η₁−η₁)=η₁−3μ−4λ>π_{kU}−3μ−4λ=αₖ+δₖ+3μ+4λ−3μ−4λ=αₖ+δₖ. The residency time constraints are violated for Step k, kε{1, 4}. If π_{Umin}=π_{2U}, by (3.4), one has τ₂₁=η−5μ−8λ−α₃−α₂−ω₁≧η−5μ−8λ−α₃−α₂−(η−η₁)=η₁−5μ−8λ−α₃−α₂>π_{2U}−5μ−8−α₃−α₂=2α₂+α₃+5μ+8λ−5μ−8λ−α₃−α₂=α₂+δ₂. The residency time constraints are violated for Step 2. If π_{Umin}=π_{3U}, by (3.4), one has τ₃₂=η−5μ−8λ−α₃−α₂−ω₂≧η−5μ−8λ−α₃−α₂−(η−η₁)=η₁5μ−8λ−α₃−α₂>π_{3U}−5μ−8λ−α₃−α₂=2α₃+α₂+5μ+8λ−5μ−8λ−α₃−α₂=α₃+δ₃. The residency time constraints are violated for Step 3. Thus, in any case, no matter how ωᵢ's are set, a feasible schedule cannot be found.

Next one discusses the schedulability and scheduling problem when η₁<π_{Umin}. One has the following two cases.

[π_{1L},π_{1U}]∩[π_{2L},π_{2U}]∩[π_{3L},π_{3U}]∩[π_{4L},π_{4U}]≠Ø \textcircled{1}

[π_{1L},π_{1U}]∩[π_{2L},π_{2U}]∩[π_{3L},π_{3U}]∩[π_{4L},π_{4U}]=Ø \textcircled{2}

For Case \textcircled{1}, one has the following lemmas.

Lemma 2: If η₁<π_{Lmax}, let ω₀=ω₁=ω₂=ω₃=0 and ω₄=π_{Lmax}−η₁, the obtained schedule is feasible.

Proof By the obtained schedule, the cycle time for the tool is θ=η=π_{Lmax}. In this case, one has π_{iL}≦θ=η=π_{Lmax}≦π_{iU}, iεN₄. Then, for Step i, iε{1, 4}, by (3.2) and (3.3), τᵢ=π_{Lmax}−3μ−4λ≧π_{iL}−3μ−4λ=αᵢ and τᵢ=π_{Lmax}−3μ−4λ≦π_{iU}−3μ−4λ=αᵢ+δᵢ, or the wafer residency time constraints are satisfied. For Step 2, by (3.4), τ₂₁=π_{Lmax}−5μ−8λ−α₃−α₂≧π_{2L}−5μ−8λ−α₃−α₂=α₂ and τ₂₁π_{Lmax}−5μ−8λ−α₃−α₂≦π_{2U}−5μ−8λ−α₃−α₂=α₂+δ₂. By (3.5), τ₂₂=α₂. Hence, the wafer residency time constraints are satisfied for Step 2. For Step 3, by (3.6), τ₃₁=α₃. By (3.7), τ₃₂=π_{Lmax}−5μ−8λ−α₃−α₂>π_{3L}−5μ−8λ−α₃−α₂=α₃ and τ₃₂=π_{Lmax}−5μ−8λ−α₃−α₂≦π_{3U}−5μ−8λ−α₃−α₂=α₃+δ₃. Hence, the wafer residency time constraints are satisfied for Step 3. Therefore, the obtained schedule is feasible and the system is schedulable.

Lemma 3: If π_{Lmax}≦η₁≦π_{Umin}, set ω₀ω₂=ω₃=ω₄=0, the obtained schedule is feasible.

Proof:

In this case, the cycle time θ=η=η₁. Then, for Step i, iε{1, 4}, one has τᵢ=η₁−3μ−4λ≧π_{iL}−3μ−4λ=αᵢ and τᵢ=η₁−3μ−4λ≦π_{iU}−3μ−4λ=αᵢ+δᵢ. For Step 2, one has τ₂₁=η₁−5μ−8λ−α₃−α₂≧π_{2L}−5μ−8λ−α₃−α₂=α₂ and τ₂₁η₁−5μ−8λ−α₃−α₂≦π_{2U}−5μ−8λ−α₃−α₂=α₂+δ₂, and τ₂₂=α₂. For Step 3, one has τ₃₁=α₃, and τ₃₂=η₁−5μ−8λ−α₃−α₂≧π_{3L}−5μ8λ−α₃−α₂=α₃ and τ₃₂η₁−5μ−8λ−α₃−α₂≦π_{3U}−5μ−8λ−α₃−α₂=α₃+δ₃. Thus, for all the steps, the wafer residency time constraints are satisfied and the obtained schedule is feasible.

For Case \textcircled{2}, there must exist at least one iε [symbol] ₄ such that π_{iU}<π_{Lmax}. Let E={i|π_{iU}<π_{Lmax}, iε [symbol] ₄} and F= [symbol] ₄\E. Then, for Step i, iε [symbol] ₄, one sets ωᵢ₋₁ as follows.

$${ω}_{i - 1} = \{ \begin{matrix}0 , & i ∈ F \\ {π}_{Lmax} - {α}_{i} - {δ}_{i} - 4 λ - 3 μ , & i ∈ E ⋂ \{ 1 , 4 \} \\ {π}_{Lmax} - 2 {α}_{2} - {δ}_{2} - {α}_{3} - 5 μ - 8 λ , & i ∈ E ⋂ \{ 2 \} \\ {π}_{Lmax} - 2 {α}_{3} - {δ}_{3} - {α}_{2} - 5 μ - 8 λ , & i ∈ E ⋂ \{ 3 \}\end{matrix} \qquad ( 3.29 )$$

Then, one has the following lemma.

Lemma 4: For the case of [π_{1,L}, π_{1U}]∩[π_{2L}, π_{2U}]∩[π_{3L}, π_{3U}]#[π_{4L}, π_{4U}]=└, let

$${ω}_{4} = {π}_{Lmax} - {η}_{1} - {\sum }_{i = 0}^{3} {ω}_{i} ,$$

where ωᵢ, iεΩ₃ is determined via (3.29). Then, if ω₄≧0, the obtained schedule is feasible, otherwise the system is not schedulable.

Proof:

One first shows that when ω₄≧0, the obtained schedule is feasible. It follows from (3.29) and

$${ω}_{4} = {π}_{Lmax} - {η}_{1} - {\sum }_{i = 0}^{3} {ω}_{i}$$

that one has θ=η=π_{Lmax}. Then, for Step i, iε{1, 4}, if iεF, τᵢ=π_{Lmax}−3μ−4λ≧π_{iL}−3μ−4λ=αᵢ and τᵢ=π_{Lmax}−3μ−4λ≦π_{iU}−3μ−4λ=αᵢ+δᵢ. If iεE, τᵢ=π_{Lmax}3μ−4λ−(π_{Lmax}−αᵢ−δᵢ−4λ−3μ)=αᵢ+δᵢ. For Step 2, one has τ₂₂=α₂. If 2εF, τ₂₁=π_{Lmax}−5μ−8λ−α₃−α₂≧π_{2L}−5μ−8λ−α₃−α₂=α₂ and τ₂₁=π_{Lmax}−5μ−8λ−α₃−α₂<π_{2U}−5μ−8λ−α₃−α₂=α₂+δ₂. If 2εE, τ₂₁=π_{Lmax}5μ−8λ−α₃−α₂−(π_{Lmax}−α₂−δ₂−α₂−α₃−4λ−3μ)=α₂+δ₂. For Step 3, one has τ₃₁=α₃. If 3εF, τ₃₂=π_{Lmax}5μ−8λ−α₃−α₂≧π_{3L}−5μ−8λ−α₃−α₂=α₃ and τ₃₂=π_{Lmax}5μ−8λ−α₃−α₂<π_{3U}−5μ−8λ−α₃−α₂=α₃+δ₃. If 3εE, τ₃₂=π_{Lmax}−5μ−8λ−α₃−α₂−(π_{Lmax}−α₃−δ₃−α₂−α₃−4λ−3μ)=α₃+δ₃. Thus, the wafer residency time constraints are satisfied for all the steps and the obtained schedule are feasible.

Now one shows that the system is not schedulable if ω₄<0. When ω₄<0, the obtained schedule is meaningless, or one cannot find a feasible schedule such that θ=η=π_{Lmax}. Then, there are two choices: (1) η<π_{Lmax} and (2) η>π_{Lmax}.

If η<π_{Lmax}, one assumes that π_{iL}=π_{Lmax}, iε [symbol] ₄. If iε{1, 4}, for Step i, one has τᵢ=η−3μ−4λ−ωᵢ₋₁<π_{Lmax}−3μ−4λ−ωᵢ₋₁=π_{iL}−3μ−4λ−ωᵢ₋₁<αᵢ. If π_{2L}=π_{Lmax}, one has τ₂₁=η−5μ−8λ−α₃−α₂−ω₁<π_{Lmax}−5μ−8λ−α₃−α₂−ω₁=π_{2L}−3μ−4λ−ω₁≦α₂. If π_{3L}=π_{Lmax}, one has τ₃₂=η−5μ−8λ−α₃−α₂−ω₂<π_{Lmax}−5μ−8λ−α₃−α₂−ω₂=π_{3L}−3μ−4λ−ω₂≦α₃. This implies that the wafer residency time constraints are violated for at least one step. Thus, a feasible schedule cannot be found, it is not schedulable.

If η>π_{Lmax}, one assumes that η=π_{Lmax}+Δη and φᵢ₋₁=ωᵢ₋₁+Δωᵢ₋₁, where ωᵢ₋₁ is obtained via (3.29), iεE. Then, according to (3.1), one has

$${\sum }_{k = 1}^{4} ( {ω}_{k - 1} + Δ {ω}_{k - 1} ) \leq η - {η}_{1} = ( {π}_{Lmax} - {η}_{1} ) + Δ η \qquad ( 3.30 )$$

If π_{iL}=π_{Lmax}, iεE, and iε{1, 4}, one has π_{Lmax}+Δη=αᵢ+δᵢ+4λ+3μ+ωᵢ₋₁+Δωᵢ₋₁=π_{Lmax}+Δωᵢ₋₁. If π_{iL}=π_{Lmax}, iεE, and iε{2, 3}, one has π_{Lmax}+Δη=αᵢ+δᵢ+8λ+5μ+α₂+α₃+ωᵢ₋₁+Δωᵢ₋₁=π_{Lmax}+Δωᵢ₋₁. Thus, one has Δη=Δωᵢ₋₁=π_{Lmax} and iεE. Since ω₄<0,

$${\sum }_{k = 1}^{4} {ω}_{k - 1} > {π}_{Lmax} - {η}_{1} must hold , \\ leading to the following result \\ {\sum }_{k = 1}^{4} ( {ω}_{k - 1} + Δ {ω}_{k - 1} ) \leq η - {η}_{1} > ( {π}_{Lmax} - {η}_{1} ) + Δη \qquad ( 3.31 )$$

This contradicts to (3.30), i.e., a feasible schedule cannot be found.

Up to now, one presents the conditions under which a feasible schedule can be found for a single-cluster tool with wafer revisiting and residency time constraints. Notice that, by above analysis, for each case, one presents a schedule, then check its feasibility. Thus, if a feasible schedule exists, a feasible schedule can be found by simply setting the robot waiting time. In summary, an algorithm is presented as follows to find a schedule if it exists.

Algorithm 1: Find a feasible schedule for a single-am cluster tool with wafer residency time constraints for an ALD process if it exists as
1) If η₁<π_{Lmax}, set ω₀=ω₁=ω₂=ω₃=0 and ω₄=π_{Lmax}−η₁ to obtain a feasible schedule;
2) If π_{Lmax}≦η₁≦π_{Umin}, set ω₀=ω₁=ω₂=ω₃=ω₄=0 to obtain a feasible schedule; and
3) If [π_{1L}, π_{1U}]∩[π_{2L}, π_{2U}]∩[π_{3L}, π_{3U}]∩[π_{4L}, π_{4U}]=Ø, set ωᵢ, iεΩ₃, by using (3.29) and ω₄=

$${π}_{Lmax} - {η}_{1} - {\sum }_{i = 0}^{3} {ω}_{i} .$$

Then, if ω₄≧0, a feasible schedule is obtained.

By Algorithm 1, only simple calculation is needed such that the proposed method is computationally very efficient. Another issue for scheduling problem is its productivity. The following theorem shows the optimality of the proposed method.

Theorem 1: If the system is schedulable, the obtained schedule by methods given in Lemmas 2 to 4 is optimal in terms of productivity.

Proof Let π_{iL}=π_{Lmax}, iε [symbol] ₄. According to Lemmas 2 and 4, if the system is scheduled such that θ=η<π_{Lmax}, from (3.2)-(3.7), one has τᵢ<αᵢ, if π_{iL}=π_{Lmax} and iε{1, 4}; τ₂₁<α₂, if π_{2L}=π_{Lmax}, and τ₃₂<α₃, if π_{3L}=π_{Lmax}. In other words, the obtained schedule is not feasible. Thus, by the algorithms given in Lemmas 2 and 4, the obtained schedule has a minimal cycle time, or maximal productivity.

### C. ILLUSTRATIVE EXAMPLES

This section uses examples with wafer flow pattern (PM₁, (PM₂, PM₃)², PM₄) to show the proposed method.

### Example 1

The wafer processing time at PM₁₋₄ is α₁=120 s, α₂=40 s, α₃=45 s, and α₄=125 s, respectively. After a wafer is completed, it can stay in PM₁₋₄ for at most δ₁=30 s, δ₂=20 s, δ₃=20 s, and δ₄=30 s, respectively. The robot task time is λ=μ=3 s.

For this example, one has π_{1L}=141 s, π_{1U}=171 s, π_{2L}=164 s, π_{2U}=184 s, π_{3L}=169 s, π_{3U}=189 s, π_{4L}=146 s, π_{1U}=176 s, π_{Lmax}=169 s, and ƒ₁=163 s. One can check that [π_{1L}, π_{1U}]∩[π_{2L}, π_{2U}]∩[π_{3L}, π_{3U}]∩[π_{4L}, π_{4U}]≠Ø and η₁≦π_{Lmax}. Then, according to Lemma 2, one sets ω₀=ω₁=ω₂=ω₃=0 and ω₄=π_{Lmax}−η₁=6 s and a feasible schedule is obtained with cycle time θ=η=π_{Lmax}=169 s.

### Example 2

The wafer processing time at PM₁₋₄ is α₁=95 s, α₂=35 s, α₃=30 s, and α₄=100 s, respectively. After a wafer is completed, it can stay in PM₁₋₄ for at most δ₁=30 s, δ₂=20 s, δ₃=20 s, and δ₄=30 s respectively. The robot task time is λ=μ=3 s.

One has π_{1L}=116 s, π_{1U}=146 s, π_{2L}=139 s, π_{2U}=159 s, π_{3L}=134 s, π_{3U}=154 s, π_{4L}=121 s, π_{4U}=151 s, π_{Lmax}=139 s, and η₁=143 s. Thus, [π_{1L}, π_{1U}]∩[π_{2L}, π_{2U}]∩[π_{3L}, π_{3U}]∩[π_{4L}, π_{4U}]#Ø and π_{Lmax}≦η₁≦π_{Umin} hold, and it is schedulable. Then, according to the algorithm given in Lemma 3, one sets ω₀=ω₁=ω₂=ω₃=ω₄=0 s and a feasible schedule is obtained with cycle time θ=η=η₁=143 s.

### Example 3

The wafer processing time at PM₁₋₄ is α₁=115 s, α₂=40 s, α₃=45 s, and α₄=125 s, respectively. After a wafer is completed, it can stay at PM₁₋₄ for at most δ₁=30 s, δ₂=20 s, δ₃=20 s, and δ₄=30 s, respectively. The robot task time is λ=μ=3 s.

For this example, one has π_{1L}=136 s, π_{1U}=166 s, π_{2L}=164 s, π_{2U}=184 s, π_{3L}=169 s, π_{3U}=189 s, π_{4L}=146 s, π_{4U}=176 s, π_{Lmax}=169 s, and η₁=163 s. It can be checked that [π_{1L}, π_{1U}]∩[π_{2L}, π_{2U}]∩[π_{3L}, π_{3U}]∩[π_{4L}]=Ø and E={1}. According to Lemma 4, one sets ω₀=3, ω₁=ω₂=ω₃=0, and ω₄=3. Since ω₄>0, the system is schedulable and the obtained schedule is feasible with cycle time θ=η=π_{Lmax}=169 s. Based on the PN model, one shows how this schedule is implemented as follows. According to the system modeling, one has M₀=({null}, {V₃(1)}, {V₂(2)}, {V₁(1)}) and one assumes the starting time is γ₀=0. Then, the system evolves as follows.

1) From γ₀=0 to γ₁=15, task sequence <y₂₀→robot waits in q₀₂→s₀₂→t₀₁→s₁₁> such that M₁=({W₁(1)}, {W₀(1)}, {W₀(2)}, {W₀(1)}) is reached.
2) From γ₁=15 to γ₂=30, task sequence <y₁₄→robot waits in q₄₂→s₄₂→t₄₀→s₀₁> such that M₂=({W₁(1)}, {V₀(1)}, {V₀(2)}, {null}) is reached.
3) From γ₂=30 to γ₃=42, task sequence <y₀₃→robot waits in q₃₂→s₃₂→t₃₄→s₄₁> such that M₃=({W₁(1)}, {V₀(1)}, {null}, {V₀(1)}) is reached.
4) From γ₃=42 to γ₄=54, task sequence <y₄₂→robot waits in q₂₂→s₂₂→t₂₃→s₃₁> such that M₄=({W₁(1)}, {null}, {V₀(1)}, {V₀(1)}) is reached.
5) From γ₄=54 to γ₅=108, task sequence <y₃₃→robot waits at step 3→s₃₂→t₃₂→s₂₁> such that M₅=({W₁(1)}, {V₀(2)}, {null}, {V₀(1)}) is reached.
6) From γ₅=108 to γ₆=157, task sequence <y₂₂→robot waits at step 2→s₂₂→t₂₃→s₃₁> such that M₆=({W₁(1)}, {null}, {V₀(2)}, {V₀(1)}) is reached.
7) From γ₆=157 to γ₇=169, task sequence <y₃₁→robot waits in q₁₂→s₁₂→t₁₂→s₂₁> such that M₇=({null}, {W₁(1)}, {V₀(2)}, {V₀(1)}) is reached.

Through the above sequence, a cycle of the system is formed, which demonstrates that the cycle time is 169 s.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but is not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer-implemented method for scheduling a cluster tool, the cluster tool comprising a single-arm robot for wafer handling, a wafer-processing system comprising four process modules including PM₁, PM₂, PM₃, and PM₄, each for performing a wafer-processing step with a wafer residency time constraint where the ith process module, iε{1, 2, . . . , 4}, is used for performing Step i of the wafer-processing steps for each wafer, and a wafer flow pattern having (PM₁, (PM₂, PM₃)^{h}, PM₄) with (PM₂, PM₃)^{h} being the revisiting process and h≧2, the method comprising:
obtaining, by a processor, a lower bound z_{iL} of a production cycle of Step i,iε{1, 2, . . . , 4}, as follows:
π_{1L}=α₁+3μ+4λ;
π_{2L}=2α₂+α₃+5μ+8λ;
π_{3L}=2α₃+α₂+5μ+8λ; and
π_{4L}=α₄+3μ+4λ;
obtaining, by a processor, an upper bound π_{iU} of a production cycle of Step i, iε{1, 2, . . . , 4}, as follows:
π_{1U}=α₁+3μ+4λ;
π_{2U}=2α₂+α₃+5μ+8λ;
π_{3U}=2α₃+α₂+5μ+8λ; and
π_{4U}=α₄+3μ+4λ;
obtaining, by a processor, a maximum lower bound π_{Lmax} as follows:
π_{Lmax}=max{π_{iL},iε [symbol] ₄};
obtaining, by a processor, a minimum upper bound π_{Umin} as follows:
π_{Umin}=min{π_{iU},iε [symbol] ₄};
determining, by a processor, a robot task time η₁ in a cycle as follows:
η₁=14λ+12μ+α₂+α₃;
determining, by a processor, a robot waiting time ωᵢ of Step i as follows:
if [π_{1L},π_{1U}]∩[π_{2L},π_{2U}]∩[π_{3L},π_{3U}]∩[π_{4L},π_{4U}]≠Ø and η₁<π_{Lmax}, then setting ω₀=ω₁=ω₂=ω₃=0, and setting ω₄=π_{Lmax}−η₁;
else if [π_{1L},π_{1U}]∩[π_{2L},π_{2U}]∩[π_{3L},π_{3U}]∩[π_{4L},π_{4U}]≠Ø and π_{Lmax}≦η₁≦π_{Umin}, then setting ω₀=ω₁=ω₂=ω₃=0;
else if [π_{1L},π_{1U}]∩[π_{2L},π_{2U}]∩[π_{3L},π_{3U}]∩[π_{4L},π_{4U}]=Ø and π_{Lmax}≦η₁≦π_{Umin}, then setting ωᵢ,iεΩ₃ by
$${ω}_{i - 1} = \{ \begin{matrix}0 , & i ∈ F \\ {π}_{Lmax} - {α}_{i} - {δ}_{i} - 4 λ - 3 μ , & i ∈ E ⋂ \{ 1 , 4 \} \\ {π}_{Lmax} - 2 {α}_{2} - {δ}_{2} - {α}_{3} - 5 μ - 8 λ , & i ∈ E ⋂ \{ 2 \} \\ {π}_{Lmax} - 2 {α}_{3} - {δ}_{3} - {α}_{2} - 5 μ - 8 λ , & i ∈ E ⋂ \{ 3 \}\end{matrix} \\ and setting {ω}_{4} = {π}_{Lmax} - {η}_{1} - {\sum }_{i = 0}^{3} {ω}_{i} ;$$
wherein:
αᵢ, iε [symbol] ₄, is a time that a wafer is processed in the ith process module;
δᵢ iε [symbol] ₄, is a longest time that a wafer stays in the ith process module after being processed;
λ is a time that a wafer is loaded or unloaded by the robot from Step i;
η is a time that a wafer is moved by the robot from Step i to Step j;
E={i|π_{iU}>π_{Lmax}, iε [symbol] ₄}; and
F= [symbol] ₄\E.

2. The method of claim 1, further comprising: determining a production cycle of the system.

3. The method of claim 1, wherein the determination of the robot waiting time is based on a Petri Net model.

4. The method of claim 1, wherein the h is 2.

5. A non-transitory computer-readable medium whose contents cause a computing system to perform a computer-implemented method for scheduling a cluster tool, the cluster tool comprising a single-arm robot for wafer handling, a wafer-processing system comprising four process modules including PM₁, PM₂, PM₃, and PM₄, each for performing a wafer-processing step with a wafer residency time constraint where the ith process module, iε{1, 2, . . . 4}, is used for performing Step i of the wafer-processing steps for each wafer, and a wafer flow pattern having (PM₁, (PM₂, PM₃)^{h}, PM₄) with (PM₂, PM₃)^{h} being the revisiting process and h≧2, the method comprising:
obtaining, by a processor, a lower bound z_{iL} of a production cycle of Step i,iε{1, 2, . . . 4}, as follows:
π_{1L}=α₁+3μ+4λ;
π_{2L}=2α₂+α₃+5μ+8λ;
π_{3L}=2α₃+α₂+5μ+8λ; and
π_{4L}=α₄+3μ+4λ;
obtaining, by a processor, an upper bound π_{iU} of a production cycle of Step i, iε{1, 2, . . . , 4}, as follows:
π_{1U}=α₁+3μ+4λ;
π_{2U}=2α₂+α₃+5μ+8λ;
π_{3U}=2α₃+α₂+5μ+8λ; and
π_{4U}=α₄+3μ+4λ;
obtaining, by a processor, a maximum lower bound π_{Lmax} as follows:
π_{Lmax}=max{π_{iL},iε [symbol] ₄};
obtaining, by a processor, a minimum upper bound π_{Umin} as follows:
π_{Umin}=min{π_{iU},iε [symbol] ₄};
determining, by a processor, a robot task time η₁ in a cycle as follows:
η₁=14λ+12μ+α₂+α₃;
determining, by a processor, a robot waiting time ωᵢ of Step i as follows:
if [π_{1L},π_{1U}]∩[π_{2L},π_{2U}]∩[π_{3L},π_{3U}]∩[π_{4L},π_{4U}]≠Ø and η₁<π_{Lmax}, then setting ω₀=ω₁=ω₂=ω₃=0, and setting ω₄=π_{Lmax}−η₁;
else if [π_{1L},π_{1U}]∩[π_{2L},π_{2U}]∩[π_{3L},π_{3U}]∩[π_{4L},π_{4U}]≠Ø and π_{Lmax}≦η₁≦π_{Umin}, then setting ω₀=ω₁=ω₂=ω₃=0;
else if [π_{1L},π_{1U}]∩[π_{2L},π_{2U}]∩[π_{3L},π_{3U}]∩[π_{4L},π_{4U}]=Ø and π_{Lmax}≦η₁≦π_{Umin}, then setting ωᵢ,iεΩ₃ by
$${ω}_{i - 1} = \{ \begin{matrix}0 , & i ∈ F \\ {π}_{Lmax} - {α}_{i} - {δ}_{i} - 4 λ - 3 μ , & i ∈ E ⋂ \{ 1 , 4 \} \\ {π}_{Lmax} - 2 {α}_{2} - {δ}_{2} - {α}_{3} - 5 μ - 8 λ , & i ∈ E ⋂ \{ 2 \} \\ {π}_{Lmax} - 2 {α}_{3} - {δ}_{3} - {α}_{2} - 5 μ - 8 λ , & i ∈ E ⋂ \{ 3 \}\end{matrix} \\ and setting {ω}_{4} = {π}_{Lmax} - {η}_{1} - {\sum }_{i = 0}^{3} {ω}_{i} ;$$
wherein:
αᵢ, iε [symbol] ₄, is a time that a wafer is processed in the ith process module;
δᵢ iε [symbol] ₄, is a longest time that a wafer stays in the ith process module after being processed;
λ is a time that a wafer is loaded or unloaded by the robot from Step i;
μ is a time that a wafer is moved by the robot from Step i to Step j;
E={i|π_{iU}<π_{Lmax}, iε [symbol] ₄}; and
F= [symbol] ₄\E.

6. The non-transitory computer-readable medium of claim 5, wherein the method further comprises: determining a production cycle of the system.

7. The non-transitory computer-readable medium of claim 5, wherein the determination of the robot waiting time is based on a Petri Net model.

8. The non-transitory computer-readable medium of claim 5, wherein the h is 2.
